(19) United States
(12) Patent Application Publication
(10) Pub. No.: US 2026/0057265 A1
(43) Pub. Date: Feb. 26, 2026

(54) METHODS AND DEVICES FOR PERFORMING ITERATIVE NASH POLICY OPTIMIZATION ON LANGUAGE MODELS

(71) Applicant: Tencent America LLC, Palo Alto, CA (US)

(72) Inventors: Dian YU, Bellevue, WA (US); Linfeng Song, Bellevue, WA (US); Haitao Mi, Palo Alto, CA (US); Dong Yu, Palo Alto, CA (US)

(73) Assignee: Tencent America LLC, Palo Alto, CA (US)

(21) Appl. No.: 18/811,980

(22) Filed: Aug. 22, 2024

(51) Int. Cl. G06N 7/00

(52) U.S. Cl. CPC G06N 7/00

(57) ABSTRACT

The present disclosure describes various methods, systems, and storage medium for training a language model to obtain an iterative Nash policy optimized (INPO) language model. The method includes initializing a first language model by a reference language model; for N-th iteration with N starting from 1 to M, generating a plurality of responses using the N-th language model for each prompt in a plurality of prompts, and constructing a preference dataset using a preference oracle based on the plurality of responses for each prompt, wherein the preference dataset comprises a winning response and a losing response; training the N-th language model to obtain a (N+1)-th language model by minimizing a value of an INPO function for all preference dataset for the plurality of prompts, wherein the INPO function comprises an expectation term, a regularization term, and a modification term; and outputting the (M+1)-th language model.

### FIELD OF THE INVENTION

The present disclosure relates to artificial intelligence and machine leaning, particularly to methods and devices for performing iterative Nash policy optimization on language models.

### BACKGROUND OF THE INVENTION

Large language models (LLMs) such as ChatGPT have achieved tremendous success in various instruction-following tasks. A key factor in this success is the technique of reinforcement learning with human feedback (RLHF) which aligns LLMs with human preferences and values. In some implementations, a reward model (RM) may be trained on a dataset containing human preferences, and then a pretrained LLM is fine-tuned to maximize the reward from this RM using the proximal policy optimization (PPO) algorithm. In some implementations, direct preference optimization (DPO) algorithm may directly learn a policy on a human preference dataset. Compared to RLHF with PPO, DPO is more stable and computationally lightweight. However, there are some issues/problems with these implementations. For example, some implementations may require a large amount of human-labeled data; some implementations may be generally less stable; some implementations may incorrectly assume that human preferences can be adequately modeled with the Bradley-Terry (BT) model.

The present disclosure describes various embodiments for training a language model to obtain an iterative Nash policy optimized (INPO) language model, addressing at least one of the issues/problems discussed above, increasing efficiency of LLMs, and improving technical features of artificial intelligence and machine leaning fields.

### SUMMARY OF THE INVENTION

In view of this, embodiments of the present disclosure are expected to provide a method, apparatus, and a storage medium for training a language model to obtain an iterative Nash policy optimized (INPO) language model.

In one embodiment, the present disclosure describes an apparatus for training a language model to obtain an iterative Nash policy optimized (INPO) language model. the apparatus includes a memory storing instructions; and a processor in communication with the memory. When the processor executes the instructions, the processor is configured to cause the apparatus to: initialize a first language model by a reference language model, for N-th iteration with N starting from 1 to M, generate a plurality of responses using the N-th language model for each prompt in a plurality of prompts, and construct a preference dataset using a preference oracle based on the plurality of responses for each prompt, wherein the preference dataset comprises a winning response and a losing response, and M is a pre-defined positive integer, train the N-th language model to obtain a (N+1)-th language model by minimizing a value of an INPO function for all preference dataset for the plurality of prompts, wherein the INPO function comprises an expectation term based on the (N+1)-th language model, a regularization term based on the reference language model, and a modification term based on the N-th language model, repeat the iteration M times, and output the (M+1)-th language model as the INPO language model.

In another embodiment, the present disclosure describes a method for training a language model to obtain an iterative Nash policy optimized (INPO) language model. The method includes initializing, by a device, a first language model by a reference language model. The device includes a memory storing instructions and a processor in communication with the memory. The method also includes for N-th iteration with N starting from 1 to M, generating, by the device, a plurality of responses using the N-th language model for each prompt in a plurality of prompts, and constructing a preference dataset using a preference oracle based on the plurality of responses for each prompt, wherein the preference dataset comprises a winning response and a losing response, and M is a pre-defined positive integer, training, by the device, the N-th language model to obtain a (N+1)-th language model by minimizing a value of an INPO function for all preference dataset for the plurality of prompts, wherein the INPO function comprises an expectation term based on the (N+1)-th language model, a regularization term based on the reference language model, and a modification term based on the N-th language model, repeating, by the device, the iteration M times, and outputting, by the device, the (M+1)-th language model as the INPO language model.

In some other embodiments, a device for training a language model to obtain an iterative Nash policy optimized (INPO) language model may include a memory storing instructions and a processing circuitry in communication with the memory. When the processing circuitry executes the instructions, the processing circuitry is configured to carry out any single step, any combinations of some steps, or all steps of the above described methods.

In some other embodiments, a non-transitory computer-readable medium comprising instructions which, when executed by a computer, cause the computer to carry out any single step, any combinations of some steps, or all steps of the above described methods.

The above and other aspects and their implementations are described in greater detail in the drawings, the descriptions, and the claims.

### BRIEF DESCRIPTION OF THE DRAWINGS

The system, device, product, and/or method described in the present disclosure may be better understood with reference to the following drawings and description of non-limiting and non-exhaustive embodiments. The components in the drawings are not necessarily to scale. Emphasis instead is placed upon illustrating the principles of the present disclosure.

FIG. 1 shows a flow diagram of an exemplary embodiment disclosed in the present disclosure.

FIG. 2 shows a schematic diagram of an exemplary embodiment in the present disclosure.

FIG. 3 shows a schematic diagram of an electronic device disclosed in the present disclosure.

FIG. 4 shows a schematic diagram of an exemplary algorithm disclosed in the present disclosure.

FIG. 5A shows evaluation results on three benchmarks for various embodiments disclosed in the present disclosure.

FIG. 5B shows ablation study of a regularization term in various embodiments disclosed in the present disclosure.

FIG. 5C shows performance on academic benchmarks for various embodiments disclosed in the present disclosure.

### DETAILED DESCRIPTION

The description and accompanying drawings above provide specific example embodiments and implementations. Drawings containing device structure and composition, for example, are not necessarily drawn to scale unless specifically indicated. Subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, or systems. Accordingly, embodiments may, for example, take the form of hardware, software, firmware or any combination thereof.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

Unless defined otherwise, all technical and scientific terms used herein have the same meaning as commonly understood by one of skill in the art to which the invention pertains. Although any methods and materials similar to or equivalent to those described herein can be used in the practice or testing of the present invention, the preferred/exemplary methods and materials are described herein.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure relates to methods, devices, and computer-readable medium for training a language model to obtain an iterative Nash policy optimized (INPO) language model.

In some implementations, large language models (LLMs) such as ChatGPT, Claude, and/or Bard, have achieved tremendous success in various instruction-following tasks. A key factor in this success is the technique of reinforcement learning with human feedback (RLHF) which aligns LLMs with human preferences and values. In some implementations, a standard RLHF framework for LLM alignment may first train a reward model (RM) on a dataset containing human preferences. Subsequently, a pretrained LLM may be fine-tuned to maximize the reward from this RM using the proximal policy optimization (PPO) algorithm. In some implementations, models trained with this pipeline may generate human-preferred outputs even with 100× fewer parameters. However, there may some issues associated with some of these implementations: for example, fitting a high-quality RM requires a large amount of human-labeled data, and training with PPO is generally less stable.

In some implementations, to bypass the training of the RM, a direct preference optimization (DPO) algorithm may directly learn a policy on a human preference dataset. Compared to RLHF with PPO, DPO is more stable and computationally lightweight. However, there may be some issues/problems associated with some of these implementations: for example, either an explicit or implicit RM may assume that human preferences can be adequately modeled with the Bradley-Terry (BT) model; and the BT model may not fully capture the complexity of human preferences. For example, the preference signal in the BT model is transitive, implying that when A is preferred to B and B is preferred to C, A must be preferred to C. In some implementations, this kind of transitive property may not always hold across diverse human groups and contradicts evidence in human decision-making. In addition, some experimental results may show that the accuracy of BT-based RMs is about 70%, while preference models outperform it by a clear margin.

The present disclosure describes embodiments including general preferences without the BT model assumption. In some implementations, the LLM alignment problem may be formulated as a symmetric two-player game; and/or for any other policy, the Nash policy of the game enjoys at least one half win rate with ignoring Kullback-Leibler (KL) regularization terms. In some implementations, given the general preference oracle, a planning algorithm may be utilizedto solve for the Nash policy.

In some implementations, reinforcement learning with human feedback (RLHF) has achieved great success in aligning large language models (LLMs) with human preferences. There may be some issues/problems associated with some of the se implementations: for example, prevalent RLHF approaches are reward-based, following the Bradley-Terry (BT) model assumption, which may not fully capture the complexity of human preferences. The present disclosure explores RLHF under a general preference framework and approach it from a game-theoretic perspective. Specifically, the problem may be formulated as a two-player game and a novel algorithm, iterative Nash policy optimization (INPO) may be utilized. The key idea is to let the policy play against itself via no-regret learning, thereby approximating the Nash policy. Unlike some other implementations, INPO bypasses the need for estimating the expected win rate for individual responses, which typically in-curs high computational or annotation costs. Instead, a new loss objective that is directly minimized over a preference dataset may be introduced. The present disclosure also describes some theoretical analysis and demonstrates its effectiveness through experiments on various representative benchmarks. For example, with an LLaMA-3-8B-based SFT model, some embodiments in the present disclosure may achieve a 41.5% length-controlled win rate on AlpacaEval 2.0 and a 38.3% win rate on Arena-Hard, showing substantial improvement over other state-of-the-art iterative algorithm under the BT model assumption. Additionally, some ablation study highlights the benefits of incorporating KL regularization for response length control.

In various embodiments in the present disclosure, the learning problem is considered, wherein the general preference oracle is unknown to us, and only access to query the oracle is available. In some implementations, inspired by the connections between constant-sum games and online learning, a no-regret learning algorithm may be used to learn the Nash policy. The key idea originates from the self-play algorithms used in games, where the policy plays against itself to achieve self-improvement.

In the present disclosure, RLHF for LLM alignment may be studied from a game-theoretic perspective. In some implementations, a novel self-play algorithm called iterative Nash policy optimization (INPO) may learn the Nash policy of a two-player game. Some approach is built on the classical no-regret learning algorithm, online mirror descent (OMD). Unlike some previous studies that also explore self-play algorithms for learning the Nash policy, some implementations do not require calculation of the expected win rate for each response, which is difficult to estimate accurately and may incur high costs in practice. Instead, a new loss objective may be utilized and the minimizer of this loss uniquely may correspond to a target policy in each iteration. Therefore, some implementations may directly learn the policy over a preference dataset.

The present disclosure describes the theoretical analysis, and experiments that are conducted on several popular benchmarks to demonstrate the effectiveness of INPO. For example, remarkably, with an SFT model from LLaMA-3-8B, some INPO embodiments achieve a 41.5% length-controlled win rate on AlpacaEval 2.0 and a 38.3% win rate on Arena-Hard v0.1, exhibiting a 45.6% and 25.2% relative improvement over some other state-of-the-art iterative DPO, respectively. The present disclosure also describes some ablation study to examine the importance of including KL regularization terms in the game objective, which is beneficial for controlling the length of the generated responses.

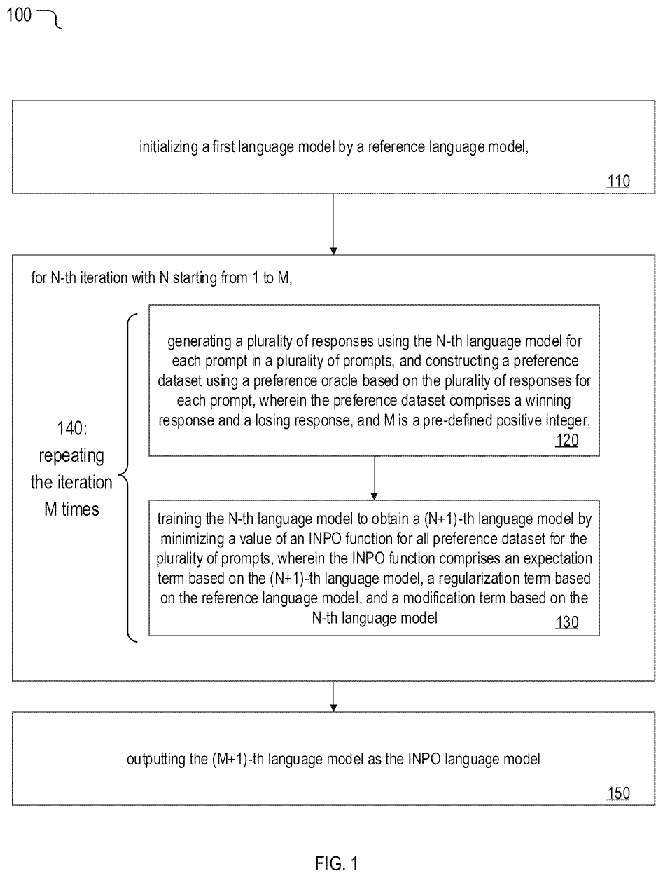

Referring to FIG. 1, various embodiments in the present disclosure may include a method 100 for training a language model to obtain an iterative Nash policy optimized (INPO) language model. The method may be preformed by an electronic device comprising a memory and a processor, wherein the memory is configured to store computer-readable instructions, and the processor is in communication with the memory and is configured to execute the instructions. The method 100 may include a portion or all of the following: step 110, initializing a first language model by a reference language model, step 120, for N-th iteration with N starting from 1 to M, generate a plurality of responses using the N-th language model for each prompt in a plurality of prompts, and constructing a preference dataset using a preference oracle based on the plurality of responses for each prompt, wherein the preference dataset comprises a winning response and a losing response, and M is a pre-defined positive integer, step 130, training the N-th language model to obtain a (N+1)-th language model by minimizing a value of an INPO function for all preference dataset for the plurality of prompts, wherein the INPO function comprises an expectation term based on the (N+1)-th language model, a regularization term based on the reference language model, and a modification term based on the N-th language model, step 140, repeating the iteration M times, and/or step 150, outputting the (M+1)-th language model as the INPO language model.

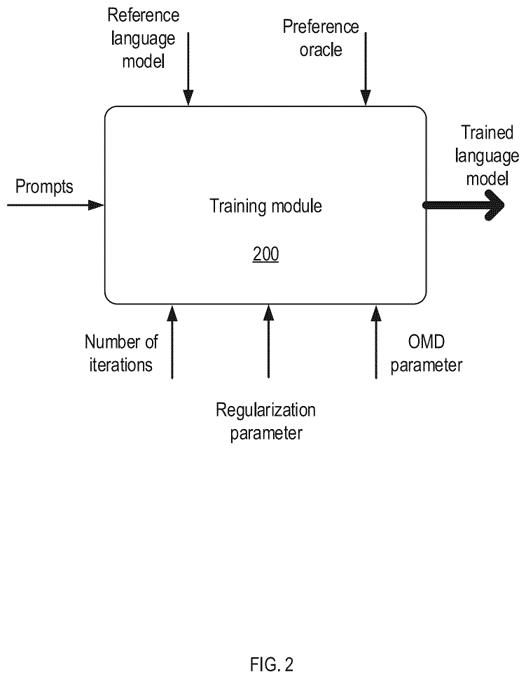

Referring to FIG. 2, a training module 200 may be utilized to train a language model, and output an iterative Nash policy optimized (INPO) language model (as a trained language model). The training module 200 may include a portion or all of the following inputs: a plurality of prompts, a reference language model, a reference oracle, a number of iterations, a regularization parameter, and/or an online mirror descent (OMD) parameter.

In various embodiments in the present disclosure, a module may refer to a software module, a hardware module, or a combination thereof. A software module may include a computer program or part of the computer program that has a pre-defined function and works together with other related parts to achieve a pre-defined goal, such as those functions described in this disclosure. A hardware module may be implemented using processing circuitry and/or memory configured to perform the functions described in this disclosure. Each module can be implemented using one or more processors (or processors and memory). Likewise, a processor (or processors and memory) can be used to implement one or more modules. Moreover, each module can be part of an overall module that includes the functionalities of the module. The description here also applies to the term module and other equivalent terms.

In some implementations, the method may further include a portion or all of the following: generating a predicated answer using the INPO language model based on an input prompt from a user; outputting the predicated answer to a user; displaying the predicated answer on a display to a user; and/or transmitting the predicated answer to a user in a wireless or wired communication. In some implementations, the user, upon receiving the predicated answer, may determine what to do as a next step, for example, taking an action based on the predicated answer, and/or constructing a follow-up prompt based on the predicated answer.

In some implementations, a language model, as an LLM including a plurality of parameters, is an artificial intelligence programs that include neural networks to process input text and generate output content. The language model may include a portion or all of the following: one or more recurrent layers, one or more feedforward layers, one or more embedding layers, and/or one or more attention layers. In some implementations, training the language model may refer to adjusting the plurality of parameters of the language model based on the training data according to training criteria (e.g., minimizing a value of a loss function).

In some implementations, the reference language model is a supervised fine-tuned (SFT) language model.

In some implementations, the preference oracle may take a pair of responses as input, and outputs which one response in the pair of responses is more preferred than the other response in the pair of responses. The response that is more preferred is referred as a winning response; and the other response that is less preferred (or not preferred) is referred as a losing response. The preference oracle may determine the winning response in the pair of responses without calculating an expected winning rate for each response. In some implementations, the preference oracle's output may be constructed as a preference dataset y_winning, y_lossing, wherein y_winning is the winning response, and y_lossing is the losing response.

In some implementations, the INPO function comprises an over-fitting avoidance term based on an online mirror descent (OMD) parameter.

In some implementations, the regularization term is based on Kullback-Leibler (KL) objective.

In some implementations, the value of the INPO function is calculated according to the following:

$${( log \frac{{π}_{N + 1} ( {y}_{w} )}{{π}_{N + 1} ( {y}_{l} )} - \frac{τ}{η} log \frac{{π}_{ref} ( {y}_{w} )}{{π}_{ref} ( {y}_{l} )} - \frac{η - τ}{η} log \frac{{π}_{N} ( {y}_{w} )}{{π}_{N} ( {y}_{l} )} - \frac{1}{2 η} )}^{2}$$

wherein: π_{ref} represents the reference language model, π_{N} represents the N-th reference language model, π_{N+}1 represents the (N+1)-th reference language model, y_{w} represents the winning response, yₗ represents the losing response, τ represents a KL regularization parameter, and η represents an OMD parameter; and π(y) represent y's predication score (or a predication probability) by a language model π.

In some implementations,

$$log \frac{{π}_{N + 1} ( {y}_{w} )}{{π}_{N + 1} ( {y}_{l} )}$$

represents an expectation term based on the (N+1)-th language model;

$$\frac{τ}{η} log \frac{{π}_{ref} ( {y}_{w} )}{{π}_{ref} ( {y}_{l} )}$$

represents a regularization term based on the reference language model;

$$\frac{η - τ}{η} log \frac{{π}_{N} ( {y}_{w} )}{{π}_{N} ( {y}_{l} )}$$

represents a modification term based on the N-th language model; and/or

$$\frac{1}{2 η}$$

represents an over-fitting avoidance term based on an online mirror descent (OMD) parameter.

In some implementations, the plurality of responses comprises two responses for each prompt, and one of the plurality of responses is the winning response, and the other is the losing response. As the plurality of responses comprises two responses, the two responses may be input into the preference oracle to determine the winning response in the pair of responses.

In some implementations, the plurality of responses comprises more than two responses for each prompt, and when the processor is configured to cause the apparatus to construct the preference dataset, the processor is configured to cause the apparatus to: partition the more than two responses into a plurality of pairs, in a tournament-type selection, determine, using the preference oracle, a final winning response and a final losing response, respectively. For a non-limiting example, the plurality of responses comprises four responses (e.g., A, B, C, and D), and are partitioned into two pairs (e.g., a first pair: A and B, and a second pair: C and D). For the first pair, the preference oracle determines a winning response (e.g., winning_1) and a losing response (losing_1); and for the second pair, the preference oracle determines a winning response (e.g., winning 2) and a losing response (losing 2). The winning__1 and winning__2 are partitioned as a new pair, and the preference oracle determines a final winning response (e.g., winning f) as the winning response for the plurality of responses. Respectively, the losing_1 and losing__2 are partitioned as another new pair, and the preference oracle determines a final losing response (e.g., losing f) as the losing response for the plurality of responses.

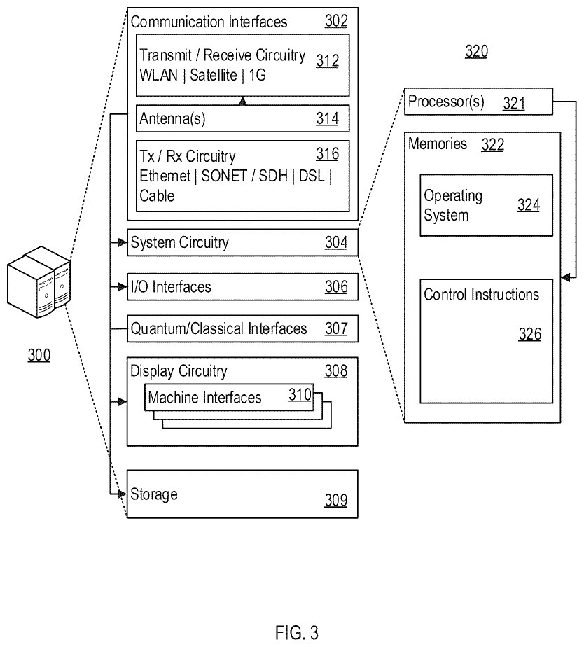

Referring to FIG. 3, a computer system (electronic device) 300 may include communication interfaces 302, system circuitry 304, input/output (I/O) interfaces 306, storage 309, and display circuitry 308 that generates machine interfaces 310 locally or for remote display, e.g., in a web browser running on a local or remote machine. The machine interfaces 310 and the I/O interfaces 306 may include GUIs, touch sensitive displays, voice or facial recognition inputs, buttons, switches, speakers and other user interface elements.

The machine interfaces 310 and the I/O interfaces 306 may further include communication interfaces with modulators, sensors, and/or detectors. The communication between the computer system 300 and the sensors and detector may include wired communication or wireless communication. The communication may include but not limited to, a serial communication, a parallel communication; an Ethernet communication, a USB communication, and a general purpose interface bus (GPIB) communication. Additional examples of the I/O interfaces 306 include microphones, video and still image cameras, headset and microphone input/output jacks, Univer-sal Serial Bus (USB) connectors, memory card slots, and other types of inputs. The I/O interfaces 306 may further include magnetic or optical media interfaces (e.g., a CDROM or DVD drive), serial and parallel bus interfaces, and keyboard and mouse interfaces. The quantum-classical interface may include a interface communicating with a quantum computer.

The communication interfaces 302 may include wireless transmitters and receivers (“transceivers”) 312 and any antennas 314 used by the transmitting and receiving circuitry of the transceivers 312. The transceivers 312 and antennas 314 may support Wi-Fi network communications, for instance, under any version of IEEE 802.11, e.g., 802.11n or 802.11ac. The communication interfaces 302 may also include wireline transceivers 316. The wireline transceivers 316 may provide physical layer interfaces for any of a wide range of communication protocols, such as any type of Ethernet, data over cable service interface specification (DOCSIS), digital subscriber line (DSL), Synchronous Optical Network (SONET), or other protocol. In another implementation, the communication interfaces 302 may further include communication interfaces with the modulators, sensors, and/or detectors.

The storage 309 may be used to store various initial, intermediate, or final data. In one implementation, the storage 309 of the computer system 300 may be integral with a database server. The storage 309 may be centralized or distributed, and may be local or remote to the computer system 300. For example, the storage 309 may be hosted remotely by a cloud computing service provider.

The system circuitry 304 may include hardware, software, firmware, or other circuitry in any combination. The system circuitry 304 may be implemented, for example, with one or more systems on a chip (SoC), application specific integrated circuits (ASIC), microprocessors, discrete analog and digital circuits, and other circuitry. For example, the system circuitry 304 may include one or more instruction processors 321 and memories 322. The memories 322 stores, for example, control instructions 326 and an operating system 324. In one implementation, the instruction processors 321 execute the control instructions 326 and the operating system 324 to carry out any desired functionality related to the controller.

The electronic device in the present disclosure and/or the methods described in the present disclosure may be implemented by a portion or all of the computer system 300 as described above. The present disclosure describes various exemplary embodiments for training a language model to obtain an iterative Nash policy optimized (INPO) language model, and the exemplary embodiments merely serve as examples and do not pose limitations. Any steps and/or operations in one same em-bodiment/implementation or more than one different embodiments/implementation in the present disclosure may be combined or arranged in any amount or order, as desired. Two or more of the steps and/or operations may be performed in parallel. Embodiments and implementations in the disclosure may be used separately or combined in any order. Further, each of the methods (or embodiments) may be implemented by processing circuitry (e.g., one or more processors or one or more integrated circuits).

In various embodiments in the present disclosure, x ∈ [symbol] is used to denote a prompt where [symbol] is the prompt space. It may be assumed that x is sampled from a fixed but unknown distribution do. An LLM is characterized by a policy π: [symbol] →Δ( [symbol] ) which takes a prompt as the input and output a distribution over the response space [symbol] . A response y ∈ [symbol] is then sampled from the distribution π(·|x). In some implementations, a may be used to denote the sigmoid function and Ber(·) to denote the Bernoulli distribution. In some implementations, [symbol] (·) may be used to hide absolute constants and [symbol] (·) is used to hide logarithmic factors. For a positive integer T, [T] denotes the set {1, 2, . . . , T}.

General Preference Oracle In some implementations, a definition of the general preference oracle may be as the following. There exists a preference oracle [symbol] : [symbol] × [symbol] × [symbol] →[0, 1], which can be queried to receive the preference signal:

$$z ∼ Ber ( ℙ ( {y}^{1} ≻ {y}^{2} \vert x ) ) ,$$

wherein z=1 means y¹ is preferred to y², and z=0 means that y² is preferred.

Given the preference oracle, the preference distribution λₚ may be introduced. For any x ∈ [symbol] and y, y′ ∈ [symbol] , there is the following:

$${λ}_{p} ( x , y , {y}^{′} ) = \{ \begin{matrix}( y , {y}^{′} ) & with probability ℙ ( y ≻ {y}^{′} \vert x ) \\ ( {y}^{′} , y ) & with probability 1 - ℙ ( y ≻ {y}^{′} \vert x )\end{matrix} . \qquad ( 1 )$$

The present disclosure describes various embodiments for learning a policy 7 that has a high probability of generating a preferred response y given the prompt x.

Bradley-Terry (BT) Model Assumption. In some implementations, instead of directly considering the general preference, the prevalent RLHF framework makes the Bradley-Terry (BT) model assumption. It assumes that there exists a reward function R* such that for any x ∈ [symbol] and y¹, y² ∈ [symbol] :

$$ℙ ( {y}^{1} ≻ {y}^{2} \vert x ) = \frac{exp ( {R}^{*} ( x , {y}^{1} ) )}{exp ( {R}^{*} ( x , {y}^{1} ) ) + exp ( {R}^{*} ( x , {y}^{2} ) )} = σ ( {R}^{*} ( x , {y}^{1} ) - {R}^{*} ( x , {y}^{2} ) ) .$$

After learning a reward function R, previous RLHF algorithms aim to maximize the following KL-regularized objective:

$$J ( π ) = {𝔼}_{x ∼ {d}_{0}} [ {𝔼}_{y ∼ π ( \cdot \vert x )} [ R ( x , y ) ] - τ KL ( π ( \cdot \vert x ) \vert \vert {π}_{ref} ( \cdot \vert x ) ) ] . \qquad ( 2 )$$

Here π_{ref} is the reference policy, which is usually a supervised fine-tuned LLM, and τ>0 is the regularization parameter. By maximizing the objective, the obtained policy simultaneously achieves a high reward and stays close to π_{ref}, which can mitigate reward hacking to some extent.

Direct Preference Optimization (DPO). In some implementations, a direct preference optimization (DPO) algorithm may directly optimize a policy and bypass the need to learn a reward function. The key idea is that there is a closed-form solution to Eq. (2):

$${π}^{*} ( y \vert x ) ∝ {π}_{ref} ( y \vert x ) exp ( \frac{1}{τ} R ( x , y ) ) ,$$

which shows that each policy π implicitly parameterizes a reward function. A maxi-mum likelihood objective may be directly formulated to learn the optimal policy:

$$- {𝔼}_{x , {y}_{w} , {y}_{l} ∼ 𝒟} [ log σ ( τ log \frac{π ( {y}_{w} \vert x )}{{π}_{ref} ( {y}_{w} ∖ x )} - τ log \frac{π ( {y}_{l} \vert x )}{{π}_{ref} ( {y}_{l} ∖ x )} ) ] ,$$

wherein [symbol] is a preference dataset, (y_{w}, yₗ) is a preference pair under prompt x and y_{w} is the preferred response.

RLHF with General Preference Some of the previously mentioned algorithms may all rely on the BT model assumption, which may not hold in practice. The policy optimization problem may be formulated as a two-player game and aim to learn the Nash equilibrium (NE) of the game. Specifically, given two policies π₁ and π₂, the game objective is written as:

$$J ( {π}_{1} , {π}_{2} ) = {𝔼}_{x ∼ {d}_{0}} [ {𝔼}_{{y}_{1} ∼ {π}_{1} , {y}_{2} ∼ {π}_{2}} [ ℙ ( {y}_{1} ≻ {y}_{2} \vert x ) ] - τ KL ( {π}_{1} ( \cdot \vert x ) \vert \vert {π}_{ref} ( \cdot \vert x ) ) + τ KL ( {π}_{2} ( \cdot \vert x ) \vert \vert {π}_{ref} ( \cdot \vert x ) ) ]$$

wherein π₁, the max-player, aims to maximize the objective, and π₂, the min-player, aims to minimize the objective. Without loss of generality, the policy class Π may be restricted to contain the policies with the same support set as π_{ref}. The NE of the game is then defined as:

$${π}_{1}^{*} , {π}_{2}^{*} := {arg max}_{{π}_{1} ∈ Π} {arg max}_{{π}_{2} ∈ Π} J ( {π}_{1} , {π}_{2} ) .$$

Since the game is symmetric for the two players, the Nash policies of the two players are unique and coincide, meaning that π*=π₂*=π*.

Property of Nash Policy. In some implementations, for any policy π∈ Π, J(π*, π)≥0.5, because J(π*, π*)=0.5 and π* is the best response against itself. This indicates that the win rate of π* over any policy π is at least one half if the KL divergence terms are negligible. Motivated by this property, the goal is to learn the Nash policy π*.

Online IPO. To learn the Nash policy, the following online IPO loss may be calculated.

$${𝔼}_{x ∼ {d}_{0} , y , {y}^{′} ∼ SG [ π ] , {y}_{w} , {y}_{l} ∼ {λ}_{p} ( x , y , {y}^{′} )} [ {( log ( \frac{π ( {y}_{w} \vert x ) {π}_{ref} ( {y}_{l} \vert x )}{π ( {y}_{l} \vert x ) {π}_{ref} ( {y}_{w} \vert x )} ) - \frac{1}{2 τ} )}^{2} ] ,$$

wherein SG[π] stands for a stop-gradient around πt in the data distribution. In some implementations, Nash policy is the minimizer of this loss function; and/or the IPO-MD loss may sample from a geometric mixture between the current policy and the reference policy:

$${𝔼}_{x ∼ {d}_{0} , y , {y}^{′} ∼ SG [ {π}^{1 - β} {π}_{ref}^{β} ] , {y}_{w} , {y}_{l} ∼ {λ}_{p} ( x , y , {y}^{′} )} [ {( log ( \frac{π ( {y}_{w} \vert x ) {π}_{ref} ( {y}_{l} \vert x )}{π ( {y}_{l} \vert x ) {π}_{ref} ( {y}_{w} \vert x )} ) - \frac{1}{2 τ} )}^{2} ] ,$$

wherein β∈ [0, 1] is an interpolation parameter. The present disclosure describes various embodiment for addressing the problem from the no-regret learning perspective, and/or for implementing an iterative algorithm based on the classical online mirror descent algorithm for how to effectively minimize these losses in practice.

### Algorithm In Various Embodiments

The present disclosure describes algorithm that learns the Nash policy via no-regret learning. In some implementations, merely for simplicity, the non-contextual case may be considered and/or the prompt x may be ignored. The exten-sion to contextual case is straightforward.

Online Mirror Descent for Solving Nash Policy Given the preference oracle [symbol] , the planning problem may be considered first and how to use the online mirror descent (OMD) algorithm to solve for the Nash policy is introduced. The policy π₁ may be initialized as π_{ref}. At iteration t, the current policy is πₜ and the loss function for any π ∈ Π may be calculated as:

$${ℓ}_{t} ( π ) := - {𝔼}_{y ∼ π , {y}^{′} ∼ {π}_{t}} [ ℙ ( y ≻ {y}^{′} ) ] + τ KL ( π \vert \vert {π}_{ref} ) .$$

The loss consists of two parts: the negative win rate of 7 over current policy πₜ and the KL penalty term, which keeps 7 close to the reference policy π_{ref}. In OMD with entropy regularization, the policy may minimize the following objective:

$${π}_{t + 1} = {arg min}_{π ∈ Π} 〈 ∇ {ℓ}_{t} ( {π}_{t} ) , π 〉 + η KL ( π \vert \vert {π}_{t} ) , \qquad ( 3 )$$

$$wherein {∇}_{y} {ℓ}_{t} ( {π}_{t} ) = - {𝔼}_{{y}^{′} ∼ {π}_{t}} [ ℙ ( y ≻ {y}^{′} ) ] + τ ( log \frac{{π}_{t} ( y )}{{π}_{ref} ( y )} + 1 ) ,$$

η>0 and

$$\frac{1}{η}$$

is the learning rate of OMD. There is a KL divergence term between π and πₜ in the objective. The spirit is to have a stable algorithm, requiring the next policy πₜ₊1 not only outperforms πₜ but also stays close to πₜ. Before presenting the theoretical guarantee, the bounded log density ratio assumption may be made, which is also used in previous RLHF analysis.

Bounded Log Density Ratio For each t ∈[T], let Πₜ ⊆Π be the feasible solution space such that πₜ obtained by OMD always belongs to Πₜ. Then, for any t ∈ [T] and π∈ Πₜ, it may be assumed that

$$\vert log \frac{π ( y )}{{π}_{ref} ( y )} \vert \leq B , ∀ y ∈ Supp ( {π}_{ref} ) .$$

Next, for the regret bound, the proof may follow from the classical analysis of OMD algorithm and is discussed in other portion in the present disclosure.

Regret Bound for OMD Under the assumption, let D=max_{π∈Π} KL(π∥π₁), OMD algorithm in Eq. (3) with

$$η = \frac{max ( B τ , 1 ) \sqrt{T}}{\sqrt{D}}$$

may have the following guarantee:

$${{\sum }_{t = 1}}^{T} 〈 ∇ {ℓ}_{t} ( {π}_{t} ) , {π}_{t} 〉 - {{\sum }_{t = 1}}^{T} 〈 ∇ {ℓ}_{t} ( {π}_{t} ) , {π}^{*} 〉 \leq 𝒪 ( max ( B τ , 1 ) \sqrt{TD} ) := {Reg}_{T}$$

In some implementations, in classical OMD, 71 is usually a uniform distribution and D is bounded by log [symbol] . π₁ may be initiated with π_{ref}, aligning with the practical RLHF workflow. With the regret bound, the duality gap for uniform mixture of πₜ can be shown to be well bounded.

Duality Gap Bound for Uniform Mixture Policy in OMD Let

$$\overline{π} := \frac{1}{T} {\sum }_{t = 1}^{T} {π}_{t} .$$

With the assumption and

$$η = \frac{max ( B τ , 1 ) \sqrt{T}}{\sqrt{D}} ,$$

there is:

$$DualGap ( \overline{π} ) := {max}_{{π}_{1}} J ( {π}_{1} , \overline{π} ) - {min}_{{π}_{2}} J ( \overline{π} , {π}_{2} ) \leq 𝒪 ( \frac{max ( B τ , 1 ) \sqrt{D}}{\sqrt{T}} ) .$$

Some other portion in the present disclosure describes proof that mainly relies on the convexity of [symbol] and the regret bound. For a symmetric game, π̅ is an ϵ-approximate Nash policy if DualGap(π̅)≥ϵ. According to some theorem described in the present disclosure, π̅ may approximate π* with an iteration complexity

$$\tilde{𝒪} ( \frac{1}{{ϵ}^{2}} ) .$$

However, despite the OMD algorithm already enjoying a good theoretical guarantee, it assumes of having access to [symbol] [ [symbol] (y [symbol] y′)] for any π∈Π, which is difficult to compute in practice. Therefore, t may still need to design a learning algorithm that only assumes query access to the preference oracle.

Population Loss The present disclosure also describes how to obtain a population loss objective for Eq. (3). Similar to the derivation of DPO, it may be started with the closed-form solution to Eq. (3):

$$\begin{matrix}{π}_{t + 1} ( y ) ∝ {π}_{t} ( y ) exp ( - \frac{1}{η} {∇}_{y} {ℓ}_{t} ( {π}_{t} ) ) \\ ∝ exp ( \frac{ℙ ( y ≻ {π}_{t} )}{η} ) {{π}_{ref} ( y )}^{\frac{τ}{η}} {{π}_{t} ( y )}^{1 - \frac{τ}{η}}\end{matrix} , \qquad ( 4 )$$

where [symbol] (y [symbol] πₜ) represents [symbol] [ [symbol] (y [symbol] y′)]. To avoid computing the normalization factor, for each response pair y, y′ and policy π, a function hₜ(π, y, y′) may be defined as:

$${h}_{t} ( π , y , {y}^{′} ) = log \frac{π ( y )}{π ( {y}^{′} )} - \frac{τ}{η} log \frac{{π}_{ref} ( y )}{{π}_{ref} ( {y}^{′} )} - \frac{η - τ}{η} log \frac{{π}_{t} ( y )}{{π}_{t} ( {y}^{′} )} .$$

In some implementations, an iterative algorithm may be used, hence hₜ contains both the log-likelihood of the reference policy π_{ref} and the last iteration policy πₜ. From Eq. 4, the following equality holds for any response pair y, y′ ∈ Supp(π_{ref}):

$${h}_{t} ( {π}_{t + 1} , y , {y}^{′} ) = \frac{ℙ ( y ≻ {π}_{t} ) - ℙ ( {y}^{′} ≻ {π}_{t} )}{η} . \qquad ( 5 )$$

Based on this observation, the loss function Lₜ(π) may be constructed as:

$${L}_{t} ( π ) = {𝔼}_{y , {y}^{′} ∼ {π}_{t}} [ {( {h}_{t} ( π , y , {y}^{′} ) - \frac{ℙ ( y ≻ {π}_{t} ) - ℙ ( {y}^{′} ≻ {π}_{t} )}{η} )}^{2} ] . \qquad ( 6 )$$

πₜ₊₁ is the minimizer of Lₜ(π) since Lₜ(πₜ₊₁)=0. Furthermore, in the following lemma, πₜ₊₁ is the unique minimizer of Lₜ within the policy class Π. The proof is described in other portion in the present disclosure.

Let Π={π: Supp(π)=Supp(π_{ref})}, πₜ₊₁ is the unique minimizer of Lₜ(π) in Π.

Therefore, solving for πₜ₊₁ is equivalent to finding a policy that minimizes Lₜ(π). However, there is the intractable term [symbol] (y [symbol] πₜ) in the loss. To bypass this term, the following population loss may be used:

$${𝔼}_{y , {y}^{′} ∼ {π}_{t} , {y}_{w} , {y}_{l} ∼ {λ}_{p} ( y , {y}^{′} )} [ {( {h}_{t} ( π , {y}_{w} , {y}_{l} ) - \frac{1}{2 η} )}^{2} ] . \qquad ( 7 )$$

Recall that λₚ(y, y′) is the preference distribution defined in Eq. (1) without context. In some implementations, it may be shown that the equality between Lₜ(π) and Eq. (7) in the following: For any policy π∈ Π and any iteration t ∈ [T], Lₜ(π) in Eq. (6) and expression in Eq. (7) are equal up to an additive constant independent of π. With the population loss in hand, a preference dataset with πₜ may be collected in each iteration and the loss on the dataset may be directly minimized to solve for πₜ₊₁.

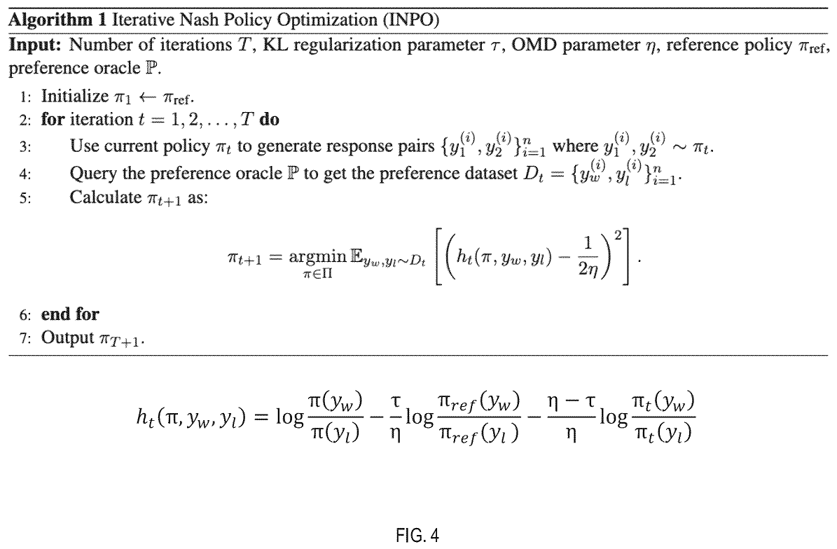

Iterative Nash Policy Optimization Algorithm FIG. 4 shows an exemplary INPO algorithm. In the beginning, a policy π₁ is initialized as the reference policy π_{ref}. For each iteration t, n response pairs may be sampled from current policy πₜ and the preference oracle [symbol] may be queried to obtain the preference dataset Dₜ. With the preference dataset, the policy πₜ₊₁ is found when minimizing the sampled version of Eq. 7. In some implementations, uniformly or weighted-average mixing the policies may be used as the final policy; and/or in some implementations, the last iteration policy π_{T+1} may be used as the final policy due to its better aligning with the practice.

In the INPO algorithm as shown in FIG. 4, the equation in Line 5 describes how INPO optimizes the policy πₜ₊₁. The term log

$$log \frac{{π}_{ref} ( {y}_{w} )}{{π}_{ref} ( {y}_{l} )}$$

to let the optimized policy πₜ₊₁ to remain close to the reference policy π_{ref} (i.e., the initial policy), thereby maintaining the ability of πₜ₊₁ to generate diverse texts. When the regularization parameter τ=0, hₜ (π, y_{w}, yₜ) simply increases the relative log probability of the winning responses to the losing ones, relative to πₜ, the policy of the previous iteration. Furthermore, INPO, which learns from the preference dataset Dₜ, represses the gap to η⁻¹/2 instead of 0, as iterative DPO does. This helps to prevent overfitting to the preference dataset.

### Derivation of Some Functions in Various Embodiments

According to the classical analysis of OMD algorithm, for any policy π,

$$\begin{matrix}{{\sum }_{t = 1}}^{T} 〈 ∇ {ℓ}_{t} ( {π}_{t} ) , {π}_{t} 〉 - {{\sum }_{t = 1}}^{T} 〈 ∇ {ℓ}_{t} ( {π}_{t} ) , π 〉 \leq η KL ( π \vert \vert {π}_{1} ) + \frac{1}{η} {{\sum }_{t = 1}}^{T} {‖ ∇ {ℓ}_{t} ( {π}_{t} ) ‖}_{∞}^{2} \\ \leq η D + \frac{( 4 {τ}^{2} {B}^{2} + 1 ) T}{η}\end{matrix} .$$

In the second step, w.l.o.g., B>1 may be assumed. Picking

$$η = \frac{max ( B τ , 1 ) \sqrt{T}}{\sqrt{D}}$$

finishes the proof.

Firstly, DualGap(\tilde{π}) may be decomposed as

$$DualGap ( \overline{π} ) = {\underbrace{{max}_{{π}_{1}} J ( {π}_{1} , \overline{π} ) - J ( {π}^{*} , {π}^{*} )}}_{Term A} + {\underbrace{J ( {π}^{*} , {π}^{*} ) - {min}_{{π}_{2}} J ( \overline{π} , {π}_{2} )}}_{Term B} .$$

Next, it is shown how to bound Term A. Since [symbol] is convex for all t, for any π,

$${{\sum }_{t = 1}}^{T} {ℓ}_{t} ( {π}_{t} ) - {{\sum }_{t = 1}}^{T} {ℓ}_{t} ( π ) \leq {{\sum }_{t = 1}}^{T} 〈 ∇ {ℓ}_{t} ( {π}_{t} ) , {π}_{t} 〉 - {{\sum }_{t = 1}}^{T} 〈 ∇ {ℓ}_{t} ( {π}_{t} ) , π 〉 \leq {Reg}_{T} . \qquad ( 8 )$$

According to the definition of [symbol] , the below is obtained,

$$\begin{matrix}\frac{1}{T} {{\sum }_{t = 1}}^{T} ( {ℓ}_{t} ( {π}_{t} ) - {ℓ}_{t} ( π ) ) = \frac{1}{T} {{\sum }_{t = 1}}^{T} ( - {𝔼}_{y ∼ {π}_{t} , {y}^{′} ∼ {π}_{t}} [ ℙ ( y ≻ {y}^{′} ) ] + τ KL ( {π}_{t} \vert \vert {π}_{ref} ) + {𝔼}_{y ∼ π , {y}^{′} ∼ {π}_{t}} [ ℙ ( y ≻ {y}^{′} ) ] - τ KL ( π \vert \vert {π}_{ref} ) \\ = \frac{1}{T} {{\sum }_{t = 1}}^{T} ( {𝔼}_{y ∼ π , {y}^{′} ∼ {π}_{t}} [ ℙ ( y ≻ {y}^{′} ) ] + τ KL ( {π}_{t} \vert \vert {π}_{ref} ) ) - τ KL ( π \vert \vert {π}_{ref} ) - \frac{1}{2} \\ \geq J ( π , \overline{π} ) - \frac{1}{2} = J ( π , \overline{π} ) - J ( {π}^{*} , {π}^{*} )\end{matrix} . \qquad ( 9 )$$

The inequality is from Jensen's inequality and convexity of KL divergence. Combining Eq. (8) and Eq. (9), it is obtained that for any π

$$J ( π , \overline{π} ) - J ( {π}^{★} , {π}^{★} ) \leq \frac{R e {g}_{T}}{T} .$$

Since the game is symmetric, Term B can also be bounded similarly. Finally, the below is obtained

$$DualGap ( \overline{π} ) \leq \frac{2 R e {g}_{T}}{T} \leq 𝒪 ( \frac{max ( {B}_{𝒯} , 1 ) \sqrt{D}}{\sqrt{T}} ) .$$

Contradiction may be used to prove the lemma. Let \tilde{π}∈Π be another policy such that \tilde{π}≠πₜ₊₁ and Lₜ(\tilde{π})=0. Let y be an arbitrary element from [symbol] . For any other y′ ∈ Supp(π_{ref}) and y′≠y, there is:

$$\frac{\tilde{π} ( y )}{\tilde{π} ( {y}^{′} )} = \frac{exp ( \frac{ℙ ( y ≻ {π}_{t} )}{η} ) {{π}_{ref} ( y )}^{\frac{τ}{η}} {{π}_{t} ( y )}^{1 - \frac{τ}{η}}}{exp ( \frac{ℙ ( {y}^{′} ≻ {π}_{t} )}{η} ) {{π}_{ref} ( {y}^{′} )}^{\frac{τ}{η}} {{π}_{t} ( {y}^{′} )}^{1 - \frac{τ}{η}}} . \qquad ( 10 )$$

Since Supp(\tilde{π})=Supp(π_{ref}), there is also Σ_{y′∈Supp(π}_{_{ref}}₎ \tilde{π}(y′)=1. Hence, the value of \tilde{π}(y) is uniquely determined. Because πₜ₊₁ also satisfies Eq. 10 and shares the same support set as \tilde{π}, there is \tilde{π}(y)=πₜ₊₁(y) and hence \tilde{π}(y′)=πₜ₊₁(y′) for all y′∈ [symbol] , contradicting with \tilde{π}≠πₜ₊₁. Therefore, the minimizer is unique.

Firstly, the following expression is considered and it equals to Lₜ(\tilde{π}) up to some constants:

$${𝔼}_{y , {y}^{′} ∼ {π}_{t} , I ∼ Ber ( ℙ ( y ≻ {y}^{′} ) )} [ {( {h}_{t} ( π , y , {y}^{′} ) - \frac{I}{η} )}^{2} ] . \qquad ( 11 )$$

It suffices to show that

$${𝔼}_{y , {y}^{′}} [ {h}_{t} ( π , y , {y}^{′} ) ( ℙ ( y ≻ {π}_{t} ) - ℙ ( {y}^{′} ≻ {π}_{t} ) ) ] = {𝔼}_{y , {y}^{′} , I} [ {h}_{t} ( π , y , {y}^{′} ) I ] .$$

$$Let {p}_{y} = ℙ ( y ≻ {π}_{t} ) and {π}_{y} = log π ( y ) , {π}_{r e f , y} = \frac{τ}{η} log {π}_{r e f} ( y ) and {π}_{t , y} = ( 1 - \frac{τ}{η} ) log {π}_{t} ( y ) .$$

For RHS, it can be written as

$$\begin{matrix}{𝔼}_{y , {y}^{′} , I} [ {h}_{t} ( π , y , {y}^{′} ) I ] \\ = {𝔼}_{y , {y}^{′} , I} [ ( {π}_{y} - {π}_{{y}^{′}} - {π}_{r e f , y} + {π}_{r e f , {y}^{′}} - {π}_{t , y} + {π}_{t , {y}^{′}} ) I ] \\ = {𝔼}_{y} [ ( {π}_{y} - {π}_{r e f , y} - {π}_{t , y} ) {𝔼}_{{y}^{′} , I} [ I ] ] + {𝔼}_{{y}^{′}} [ ( - {π}_{{y}^{′}} + {π}_{r e f , {y}^{′}} + {π}_{t , {y}^{′}} ) {𝔼}_{y , I} [ I ] ] \\ = {𝔼}_{y , {y}^{′}} [ {π}_{y} {p}_{y} - {π}_{r e f , y} {p}_{y} - {π}_{t , y} {p}_{y} - ( 1 - {p}_{{y}^{′}} ) {π}_{{y}^{′}} + ( 1 - {p}_{{y}^{′}} ) {π}_{r e f , {y}^{′}} + ( 1 - {p}_{{y}^{′}} ) {π}_{t , {y}^{′}} ] \\ = {𝔼}_{y} [ ( 2 {p}_{y} - 1 ) {π}_{y} - ( 2 {p}_{y} - 1 ) {π}_{r e f , y} - ( 2 {p}_{y} - 1 ) {π}_{t , y} ] .\end{matrix}$$

In the last step, the fact that y and y′ are from the same distribution may be used. The LHS can be written as

$$\begin{matrix}{𝔼}_{y , {y}^{′}} [ {h}_{t} ( π , y , {y}^{′} ) ( ℙ ( y ≻ {π}_{t} ) - ℙ ( {y}^{′} ≻ {π}_{t} ) ) ] \\ = {𝔼}_{y , {y}^{′}} [ ( {π}_{y} - {π}_{{y}^{′}} - {π}_{r e f , y} + {π}_{r e f , {y}^{′}} - {π}_{t , y} + {π}_{t , {y}^{′}} ) ( {p}_{y} - {p}_{{y}^{′}} ) ] \\ = {𝔼}_{y , {y}^{′}} [ 2 {p}_{y} {π}_{y} - {p}_{y} {π}_{{y}^{′}} - {p}_{{y}^{′}} {π}_{y} - 2 {p}_{y} {π}_{r e f , y} + {p}_{{y}^{′}} {π}_{r e f , y} + {p}_{y} {π}_{r e f , {y}^{′}} - 2 {p}_{y} {π}_{t , y} + {p}_{{y}^{′}} {π}_{t , y} + {p}_{y} {π}_{t , {y}^{′}} ] \\ = {𝔼}_{y} [ ( 2 {p}_{y} - 1 ) {π}_{y} - ( 2 {p}_{y} - 1 ) {π}_{r e f , y} - ( 2 {p}_{y} - 1 ) {π}_{t , y} ] .\end{matrix}$$

The second equality is from that y and y′ are from the same distribution. The last equality is from that

$${𝔼}_{y} [ {p}_{y} ] = \frac{1}{2} .$$

Therefore, it is shown that the equivalence between Lₜ(π) and Eq. 11. Next, the equivalence between Eq. 7 and Eq. 11 may be shown. The expectation over λₚ(y, y′) may be expanded and Eq. 7 may be rewritten as

$${𝔼}_{y , {y}^{′}} [ ℙ ( y ≻ {y}^{′} ) {( {h}_{t} ( π , y , {y}^{′} ) - \frac{1}{2 η} )}^{2} + ( 1 - ℙ ( y ≻ {y}^{′} ) ) {( {h}_{t} ( π , {y}^{′} , y ) - \frac{1}{2 η} )}^{2} ] .$$

The expectation over I in Eq. 11 may be expanded and written as

$${𝔼}_{y , {y}^{′}} [ ℙ ( y ≻ {y}^{′} ) {( {h}_{t} ( π , y , {y}^{′} ) - \frac{1}{η} )}^{2} + ( 1 - ℙ ( y ≻ {y}^{′} ) ) {{h}_{t} ( π , y , {y}^{′} )}^{2} ] .$$

Ignoring the constants, since hₜ(π, y, y′)=−hₜ(π, y′, y), the difference is:

$$\frac{1}{η} {𝔼}_{y , {y}^{′}} [ ℙ ( y ≻ {y}^{′} ) {h}_{t} ( π , y , {y}^{′} ) - ( 1 - ℙ ( y ≻ {y}^{′} ) ) {h}_{t} ( π , {y}^{′} , y ) ] . \qquad ( 12 )$$

For each pair y, y′, it will appear two times in the expectation and the total contri-bution is:

$$\frac{{π}_{t} ( y ) {π}_{t} ( {y}^{′} )}{η} [ ℙ ( y ≻ {y}^{′} ) {h}_{t} ( π , y , {y}^{′} ) - ℙ ( {y}^{′} ≻ y ) {h}_{t} ( π , {y}^{′} , y ) + ℙ ( {y}^{′} ≻ y ) {h}_{t} ( π , {y}^{′} , y ) - ℙ ( y ≻ {y}^{′} ) {h}_{t} ( π , y , {y}^{′} ) ] = 0. \qquad ( 13 )$$

Therefore, the expression in Eq. (12) equals to zero.

### Exemplary Embodiments: Experimental Result

The present disclosure describes some empirical results from various exemplary embodiments to demonstrate the effectiveness of the INPO algorithm. =

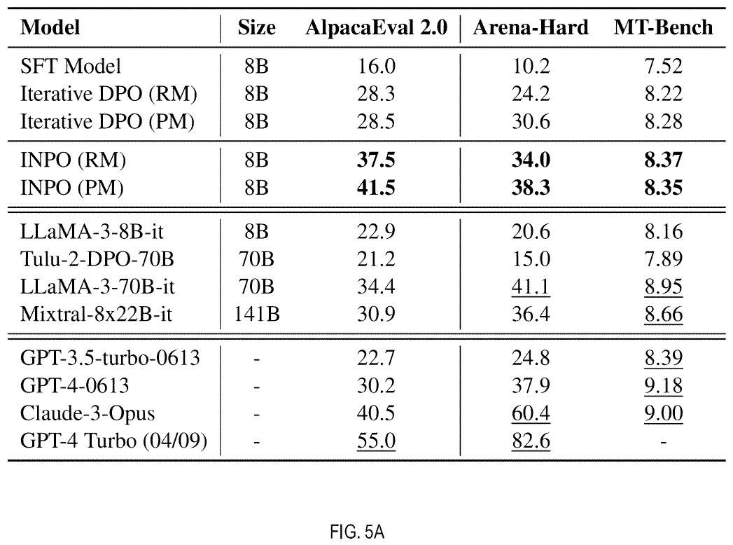

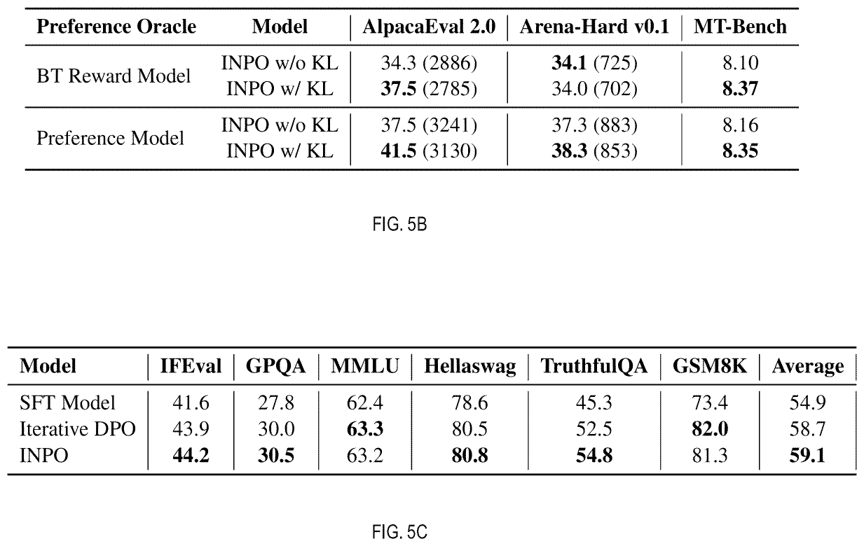

Main Results FIG. 5A shows some evaluation results on three benchmarks (win rate), wherein RM means using BT-reward model to generate preference signals, and PM means using preference model to generate preference signals. Only the underlined results outperform the 8B INPO model.

Settings. A RLHF workflow is followed and the same supervised fine-tuned (SFT) model is used, which is based on LLaMA-3-8B. The learning process of INPO lasts for T=3 iterations. In each iteration, responses from a current policy are sampled with a new set of prompts and preference signals on these responses are used to improve the policy. Instead of costly human annotations, evaluation models are employed to generate the preferences. Two choices are considered for evaluation models: the BT reward model and the preference model, which directly compares two responses and does not rely on the BT-model assumption.

The rejection sampling strategy may be utilized. For each prompt, K=8 responses may be generated and use the best-of-8 as y_{w} and the worst-of-8 as yₗ. For the BT reward model, the response with the highest reward may be selected as the best and the response with the lowest reward as the worst. For the preference model, a tournament approach may be used, selecting the winner as the best and the loser as the worst. Compared to some implementations, which estimate the expected win rate and requires [symbol] (K²) preference queries, the tournament strategy may only need [symbol] (K) queries

In some implementations, iterative DPO and their GitHub repository may be utilized. For the implementation of INPO, the hyperparameters may be utilized, including the cosine learning rate scheduler with a peak learning rate of 5×10⁻⁷, a 0.03 warm-up ratio, and a global batch size of 128. A grid search may be used for η over [0.1, 0.01, 0.0075, 0.005, 0.002] and set η=0.0075. τ is directly set to be one-third of η, which is 0.0025.

In some implementations, for the tournament strategy of the preference model, given 8 samples, the 8 samples may be split into 4 pairs and each pair is compared. If the result is a tie, the first one is selected as the winner. Then, the winners are compared against each other and the losers against each other until the final winning response y_{w} and losing response yₗ are determined. y_{ω} may be finally compared with yₗ and the model is only trained with the pairs where y_{ω} wins over yₗ. In this example, 11 comparisons in total may be needed for 8 responses.

As shown in FIG. 5A, the model performance may be evaluated on three widely used benchmarks: MT-Bench, AlpacaEval 2.0, and Arena-Hard v0.1. MT-Bench contains 80 questions from eight categories, with answers rated by GPT-4 on a scale of 1-10. Arena-Hard v0.1 contains 500 technical problem-solving questions, and the answers are compared to reference responses from the baseline model GPT-4-0314. The win rate (WR) may be reported as judged by GPT-4 Turbo (Preview-1106). AlpacaEval 2.0 includes 805 questions from five datasets, with the judge model GPT-4 Turbo (Preview-1106) comparing the answers to reference responses from itself. The length-controlled (LC) WR may be reported.

In some implementations, a win rate may be calculated as the expected probability that an evaluator, lie GPT-4 Turbo, prefers the models' outputs over reference responses.

Results and Analysis. The INPO may be compared with some iterative DPO, as shown in FIG. 5A. The INPO outperforms iterative DPO on all three benchmarks, with particularly significant improvements on AlpacaEval 2.0 and Arena-Hard v0.1. Additionally, the INPO may be compared with other LLMs, including LLaMA-3-70B-it, GPT-4-0613, Claude-3-Opus, and GPT-4 Turbo. For AlpacaEval 2.0, the INPO is only surpassed by GPT-4 Turbo and outperforms all other models. According to some results, LC AlpacaEval 2.0 has the highest correlation with Chatbot Arena, highlighting the superior performance achieved by INPO.

In some implementations, methods utilizing the preference model as the oracle generally perform better than those using the BT reward model as the oracle. This observation aligns with some other results, where the preference model outperforms the BT reward model on RewardBench, demonstrating the necessity of considering general preferences without the BT model assumption.

Ablation Study and Length Control In some implementations, an ablation study may be performed to examine the importance of including the KL regularization term in the game objective. The results are shown in FIG. 5B. The INPO with KL regularization (INPO w/KL) generally outperforms its counterpart without KL regularization (INPO w/o KL) by a clear margin. More importantly, by regu-larizing the policy towards the reference policy, shorter but still effective responses may be consistently obtained, also demonstrated by the increased LC win rate in AlpacaEval 2.0. This indicates that the regularization is beneficial for length control to some extent.

Results on Academic Benchmarks In some implementations, a RLHF alignment may have a negative effective on a model's abilities in reasoning, calibra-tion and generating accurate responses. Therefore, it may be necessary to evaluate the model performance on academic benchmarks. The results may be obtained on six academic benchmarks, evaluating various model abilities including some explicit instruction, general knowledge, multitask language understanding, commonsense reasoning, human falsehoods mimicking and math word problem-solving. The INPO with both the SFT baseline and iterative DPO may be used, and the results are shown in FIG. 5C.

In some implementations, compared to the SFT baseline, both INPO and iterative DPO exhibit performance improvements on these benchmarks. A potential reason for this is that during the alignment stage, only 60 k prompts are used in total, which is relatively small in magnitude. Additionally, both INPO and iterative DPO incorporate KL regularization, which prevents the learned policy from deviating significantly from the reference policy, thereby avoiding performance degradation.

Reward-Based RLHF. In some implementations, RLHF has achieved great success in LLM alignment, and has been extensively studied, including using RL algorithms such as PPO to maximize a KL-regularized objective and reward-ranked finetuning. In some implementations, the DPO algorithm may be used to directly optimizes the policy on a preference dataset, bypassing the need for reward model training. In some implementations, the online variant of DPO may include iterative algorithms with different exploration strategies. These works may be reward-based and rely on the BT model assumption. In some implementations, RLHF from a game-theoretic perspective may be used and a general preference may be considered.

RLHF under General Preferences. In some implementations, general preferences may be used, including an offline algorithm IPO that learns the best policy against the reference policy. In some implementations, LLM alignment may be formulated as a two-player game and a planning algorithm may be used to solve for the Nash policy when the general preference oracle is given. In some implementations, theoretical analysis may be used for both offline and online algorithms that learn the Nash policy in the game. In some implementations, an online IPO algorithm may be used to prove that the minimizer of the online IPO objective is the Nash policy of the game. However, their algorithm uses the policy gradient method, and the effective minimization of the objective remains unclear. In some implementations, an iterative algorithm may be used to learn the Nash policy, which assumes that the learner has access to the expected win rate of each response, which serves a similar role to the reward of the response. In some implementations, some closest related work may also uses no-regret learning algorithms. However, the game may be studied without KL-regularized terms. More importantly, some algorithm still requires the estimation of the expected win rate, leading to square oracle query complexity that may incur high costs in practice. In some implementations, some algorithm may directly optimize the policy over a preference dataset and bypasses the need for win rate estimation.

No-Regret Learning in Games. In some implementations, no-regret learning may be used to solve for the equilibrium of games, including matrix games, extensive-form games and Markov games. Some problem can be viewed as a contextual case of the two-player matrix game, and the classical OMD algorithm may be used to learn the Nash equilibrium.

In some other embodiments, a computer-readable medium comprising instructions which, when executed by a computer, cause the computer to carry out the above methods. The computer-readable medium may be referred as non-transitory computer-readable media (CRM) that stores data for extended periods such as a flash drive or compact disk (CD), or for short periods in the presence of power such as a memory device or random access memory (RAM). In some embodiments, computer-readable instructions may be included in a software, which is embodied in one or more tangible, non-transitory, computer-readable media. Such non-transitory computer-readable media can be media associated with user-accessible mass storage as well as certain short-duration storage that are of non-transitory nature, such as internal mass storage or ROM. The software implementing various embodiments of the present disclosure can be stored in such devices and executed by a processor (or processing circuitry). A computer-readable medium can include one or more memory devices or chips, according to particular needs. The software can cause the processor (including CPU, GPU, FPGA, and the like) to execute particular processes or particular parts of particular processes described herein, including defining data structures stored in RAM and modifying such data structures according to the processes defined by the software.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

What is claimed:

1. An apparatus for training a language model to obtain an iterative Nash policy optimized (INPO) language model, the apparatus comprising:
a memory storing instructions; and
a processor in communication with the memory, wherein, when the processor executes the instructions, the processor is configured to cause the apparatus to:
initialize a first language model by a reference language model,
for N-th iteration with N starting from 1 to M, generate a plurality of responses using the N-th language model for each prompt in a plurality of prompts, and construct a preference dataset using a preference oracle based on the plurality of responses for each prompt, wherein the preference dataset comprises a winning response and a losing response, and M is a pre-defined positive integer,
train the N-th language model to obtain a (N+1)-th language model by minimizing a value of an INPO function for all preference dataset for the plurality of prompts, wherein the INPO function comprises an expectation term based on the (N+1)-th language model, a regularization term based on the reference language model, and a modification term based on the N-th language model,
repeat the iteration M times, and
output the (M+1)-th language model as the INPO language model.

2. The apparatus according to claim 1, wherein:
the INPO function comprises an over-fitting avoidance term based on an online mirror descent (OMD) parameter.

3. The apparatus according to claim 1, wherein:
the regularization term is based on Kullback-Leibler (KL) objective.

4. The apparatus according to claim 1, wherein:
the value of the INPO function is calculated according to the following:
$${( log \frac{{π}_{N + 1} ( {y}_{w} )}{{π}_{N + 1} ( {y}_{l} )} - \frac{τ}{η} log \frac{{π}_{ref} ( {y}_{w} )}{{π}_{ref} ( {y}_{l} )} - \frac{η - τ}{η} log \frac{{π}_{N} ( {y}_{w} )}{{π}_{N} ( {y}_{l} )} - \frac{1}{2 η} )}^{2}$$
wherein: π_{ref} represents the reference language model, πN represents the N-th reference language model, π_{N+1} represents the (N+1)-th reference language model, y_{w}, represents the winning response, yₗ represents the losing response, τ represents a KL regularization parameter, and η represents an OMD parameter; and π(y) represent y's predication score by a language model π.

5. The apparatus according to claim 1, wherein:
the reference language model is a supervised fine-tuned (SFT) language model.

6. The apparatus according to claim 1, wherein:
the preference oracle outputs a winning response among a pair of responses without calculating an expected winning rate for each response.

7. The apparatus according to claim 1, wherein:
the plurality of responses comprises two responses for each prompt, and
one of the plurality of responses is the winning response, and the other is the losing response.

8. The apparatus according to claim 1, wherein:
the plurality of responses comprises more than two responses for each prompt, and
when the processor is configured to cause the apparatus to construct the preference dataset, the processor is configured to cause the apparatus to:
partition the more than two responses into a plurality of pairs, and
in a tournament-type selection, determine, using the preference oracle, a final winning response and a final losing response, respectively.

9. The apparatus according to claim 1, wherein, when the processor executes the instructions, the processor is configured to further cause the apparatus to:
generate a predicated answer using the INPO language model based on an input.

10. A method for training a language model to obtain an iterative Nash policy optimized (INPO) language model, the method comprising:
initializing, by a device comprising a memory storing instructions and a processor in communication with the memory, a first language model by a reference language model,
for N-th iteration with N starting from 1 to M, generating, by the device, a plurality of responses using the N-th language model for each prompt in a plurality of prompts, and constructing a preference dataset using a preference oracle based on the plurality of responses for each prompt, wherein the preference dataset comprises a winning response and a losing response, and M is a pre-defined positive integer,
training, by the device, the N-th language model to obtain a (N+1)-th language model by minimizing a value of an INPO function for all preference dataset for the plurality of prompts, wherein the INPO function comprises an expectation term based on the (N+1)-th language model, a regularization term based on the reference language model, and a modification term based on the N-th language model,
repeating, by the device, the iteration M times, and
outputting, by the device, the (M+1)-th language model as the INPO language model. The apparatus according to claim 1, wherein:
the periodic pattern comprises two orthogonal periodic absorptive patterns.

11. The method according to claim 10, wherein:
the INPO function comprises an over-fitting avoidance term based on an online mirror descent (OMD) parameter.

12. The method according to claim 10, wherein:
the regularization term is based on Kullback-Leibler (KL) objective.

13. The method according to claim 10, wherein:
the value of the INPO function is calculated according to the following:
$${( log \frac{{π}_{N + 1} ( {y}_{w} )}{{π}_{N + 1} ( {y}_{l} )} - \frac{τ}{η} log \frac{{π}_{ref} ( {y}_{w} )}{{π}_{ref} ( {y}_{l} )} - \frac{η - τ}{η} log \frac{{π}_{N} ( {y}_{w} )}{{π}_{N} ( {y}_{l} )} - \frac{1}{2 η} )}^{2}$$
wherein: π_{ref} represents the reference language model, π_{N} represents the N-th reference language model, π_{N+1} represents the (N+1)-th reference language model, y_{w} represents the winning response, yₗ represents the losing response, τ represents a KL regularization parameter, and η represents an OMD parameter; and π(y) represent y's predication score by a language model π.

14. The method according to claim 10, wherein:
the reference language model is a supervised fine-tuned (SFT) language model.

15. The method according to claim 10, wherein:
the preference oracle outputs a winning response among a pair of responses without calculating an expected winning rate for each response.

16. The method according to claim 10, wherein:
the plurality of responses comprises two responses for each prompt, and
one of the plurality of responses is the winning response, and the other is the losing response.

17. The method according to claim 10, wherein:
the plurality of responses comprises more than two responses for each prompt, and
the constructing the preference dataset comprises:
partitioning the more than two responses into a plurality of pairs, and
in a tournament-type selection, determining, using the preference oracle, a final winning response and a final losing response, respectively.

18. The method according to claim 10, further comprising:
generating a predicated answer using the INPO language model based on an input.

19. A non-transitory computer readable storage medium storing instructions for training a language model to obtain an iterative Nash policy optimized (INPO) language model, wherein, when the instructions are executed by a processor, the instructions are configured to cause the processor to perform:
Initializing a first language model by a reference language model,
for N-th iteration with N starting from 1 to M, generating a plurality of responses using the N-th language model for each prompt in a plurality of prompts, and constructing a preference dataset using a preference oracle based on the plurality of responses for each prompt, wherein the preference dataset comprises a winning response and a losing response, and M is a pre-defined positive integer,
training the N-th language model to obtain a (N+1)-th language model by minimizing a value of an INPO function for all preference dataset for the plurality of prompts, wherein the INPO function comprises an expectation term based on the (N+1)-th language model, a regularization term based on the reference language model, and a modification term based on the N-th language model,
repeating the iteration M times, and
outputting the (M+1)-th language model as the INPO language model.

20. The non-transitory computer readable storage medium according to claim 19, wherein:
the INPO function comprises an over-fitting avoidance term based on an online mirror descent (OMD) parameter;
the regularization term is based on Kullback-Leibler (KL) objective; and
the value of the INPO function is calculated according to the following:
$${( log \frac{{π}_{N + 1} ( {y}_{w} )}{{π}_{N + 1} ( {y}_{l} )} - \frac{τ}{η} log \frac{{π}_{ref} ( {y}_{w} )}{{π}_{ref} ( {y}_{l} )} - \frac{η - τ}{η} log \frac{{π}_{N} ( {y}_{w} )}{{π}_{N} ( {y}_{l} )} - \frac{1}{2 η} )}^{2}$$
wherein: π_{ref} represents the reference language model, π_{N} represents the N-th reference language model, π_{N+1} represents the (N+1)-th reference language model, y_{w} represents the winning response, yₗ represents the losing response, τ represents a KL regularization parameter, and η represents an OMD parameter; and π(y) represent y's predication score by a language model π.
